(19) United States
(12) Patent Application Publication
(10) Pub. No.: US 2012/0173321 A1
(43) Pub. Date: Jul. 5, 2012

(54) METHODS AND APPARATUS FOR A PROMOTIONAL COUPONING SYSTEM

(75) Inventors: Eric Meyerhofer, Pasadena, CA (US); John Hilbert, Torrance, CA (US)

(73) Assignee: FUTURELOGIC, INC., Glendale, CA (US)

(21) Appl. No.: 13/420,428

(22) Filed: Mar. 14, 2012

Related U.S. Application Data
(62) Division of application No. 12/421,373, filed on Apr. 9, 2009.
Application No. 12/421,373 is a continuation-in-part of application No. 12/088,083, filed on Apr. 6, 2009.
(60) Provisional application No. 61/043,917, filed on Apr. 10, 2008.
(60) Provisional application No. 60/722,557, filed on Sep. 30, 2005.

(51) Int. Cl. G06Q 30/02

(52) U.S. Cl. 705/14.12

(57) ABSTRACT

A promotional couponing system for the creation and management of promotional coupons, coupon templates, promotions, promotional campaigns, and triggers using a host system and a graphical front-end for use in a gaming, vending, or other business environment. A promotional couponing system runs on its own network though can connect to other host systems, and directly or indirectly to games such as slot machines and game tables and a printer of a game using a third port or interface. The promotional couponing system monitors play and other metrics to use triggers based on game and other data. The printer connection to a game only receives information which can be sent to the promotional couponing system.

### CROSS-REFERENCE TO RELATED APPLICATION(S)

This application is a continuation-in-part of U.S. application Ser. No. 12/088,083, filed Mar. 25, 2008, which is a national stage application of PCT Application No. PCT/US06/38492, filed Oct. 2, 2006, which claims the benefit of U.S. Provisional. Patent Application No. 60/722,557, filed Sep. 30, 2005, and claims the benefit of U.S. Provisional Patent Application No. 61/043,917, filed Apr. 10, 2008, the contents of each of which are hereby incorporated by reference as if stated in full herein.

### BACKGROUND OF THE INVENTION

1. Field of the Invention

This invention relates to a promotional couponing system for the creation and management of promotional coupons, coupon templates, promotions, promotional campaigns, and triggers using a host system and a graphical front-end for use in a gaming, vending, or other business environment.

2. Background

Gaming machine manufacturers have introduced cashless enabled gaming machines to the market and these have begun to find wide acceptance in the gaming industry. Cashless enabled gaming machines are so named because they can conduct financial exchanges using a mixture of traditional currencies and vouchers. Typically, a cashless enabled gaming machine has a gaming printer to produce vouchers and a bill acceptor that supports automatic reading of vouchers. To coordinate the activities of multiple cashless enabled gaming machines, one or more cashless enabled gaming machines may be electronically coupled to a cashless enabled gaming machine system that controls the cashless operations of a cashless enabled gaming machine.

Cashless enabled gaming machines have found increasing acceptance and use in the gaming industry with players who enjoy the speed of play and ease of transporting their winnings around a gaming establishment and the gaming establishments who have realized significant labor savings in the form of reduced coin hopper reloads in the games, and an increase in revenue because of the speed of play.

### SUMMARY OF THE INVENTION

The present invention is a promotional couponing system which defines coupon templates written in a template definition language, promotions, and promotional campaigns for the creation and management of promotional coupons, promotions, promotional campaigns, and triggers using a host system and a graphical front-end to a template definition language for the generation and issuance of promotional coupons in real time, based on a predetermined date and/or time, or based on other triggers by a printer for use in a gaming, vending, or other business environment. In addition, the promotional couponing system manages the redemption of promotional coupons.

In another aspect of the invention, data for promotional coupons, promotions, and promotional campaigns may be transmitted to, stored in, and used by a printer, host system, and/or a routing device. The data may be stored partially resident in the printer and partially supplied by the host system or routing device.

In another aspect of the invention, the user can move any region to another area on a promotional coupon template, place a region in front of other regions, or place a region behind other regions.

In another aspect of the invention, a user may create multiple promotional coupon templates based on existing promotional coupon templates.

In another aspect of the invention, after the gaming or other business establishment defines the print regions for the promotional coupon template, the data for the promotional coupon template is stored in a document. The document contains multiple lines. A line in the document may consist of unique identifiers for the promotional coupon template, a comment, or a command and the associated parameters required to use that promotional coupon template, among others.

In another aspect of the invention, a CRC is calculated based on the contents of the promotional coupon data.

Furthermore, the present invention allows the overall layout and print regions of a promotional coupon template to be edited or deleted. The parameters for a print region that can be edited include region ID, region data, region size, object ID, object rotation, object width, object justification, object attributes, print attributes, and print color, among others.

The data for a promotion is transmitted to and stored on the host system and may be used in one or a plurality of promotional campaigns. Promotion data may include a unique identifier for each promotion. The data also may include the unique identifier of each associated promotional coupon to interlock data in each promotion with data in each associated promotional coupon. Data created for a promotion or a plurality of promotions may be transmitted to, stored in, and used by a printer to generate one or a plurality of promotional coupons. The data may also be transmitted to and stored in a routing device or a plurality of routing devices, each coupled to a host system and a printer or a plurality of printers, each routing device transmitting the stored data to a printer to generate a promotional coupon or plurality of such.

In another aspect of the invention, the present invention calculates the CRC based on the contents of the promotion data.

The data for a promotional campaign is transmitted to and stored on the host system. Data for a promotional campaign may include a unique identifier for each promotional campaign. The data also may include the unique identifier for each associated promotion, each associated promotional coupon, or a combination thereof. Data created for a promotional campaign may be transmitted to, stored in, and used by a printer to generate one or a plurality of promotional coupons. The data may also be transmitted to and stored in a routing device or a plurality of routing devices, each coupled to a host system and a printer or a plurality of printers, each routing device transmitting the stored data to a printer to generate a promotional coupon or plurality of such.

In addition, the present invention allows the export of promotional coupon templates and data for promotional coupons, promotions, and promotional campaigns for incorporation and use by external software applications such as a casino management system or player tracking system.

In another aspect of the invention, a gaming or other business establishment can also view the status of a printer.

In another aspect of the present invention, data for a promotional campaign that may be transmitted to a printer from a host system or routing device, stored in, and used by a printer to generate a promotional coupon or a plurality of promotional coupons, may be combined with data for a promotional coupon or plurality of promotional coupons.

In another aspect of the present invention, a boundary check on the combined promotional coupon template or plurality of promotional coupon templates, print regions, graphics and other data which may be included with the promotion or promotional campaign data may be performed to ensure conformance with the resources and load requirements of the printer.

In another aspect of the present invention, data for promotional coupon templates, promotions, and promotional campaigns is stored in the memory of the printer.

In another aspect of the present invention, data for promotional coupon templates, promotions, and promotional campaigns is stored in a routing device or a plurality of routing devices, each coupled to a host system and a printer or a plurality of printers.

In another aspect of the invention, the promotional couponing system monitors and tracks the redemption of promotional coupons.

In another aspect of the invention, to allow redemption of the promotional coupon, the data may be verified against data originally used to create a promotional coupon template, promotion, promotional campaign, a plurality of any, or a combination of any.

In another aspect of the invention, the promotional couponing system is coupled to a point-of-sale server to validate the redemption of promotional coupons.

In another aspect of the invention, the promotional couponing system is coupled to a gateway server or a plurality of such, each gateway server coupled to a cluster controller, which controls a plurality of games.

In another aspect of the invention, the promotional couponing system is coupled to player tracking server to validate the redemption of promotional coupons.

In another aspect of the invention, the promotional couponing system is coupled to a slot accounting server to request data for the issuance of a promotional coupon or plurality of such based on a promotional coupon template.

In another aspect of the invention, the promotional couponing system is coupled to a slot accounting server to verify the issuance of a promotion coupon or plurality of such based on a promotional coupon template.

In another aspect of the invention, the promotional couponing system is on its own LAN and not connected to one or a plurality of systems in use at a gaming establishment or other business establishment or shares bandwidth with one or a plurality of systems talking a different protocol, for example, it cannot control the game.

In another aspect of the invention, the promotional couponing system monitors slot machine play metrics and/or game play metrics directly from the slot machine or game using a connection to the Slot Machine Interface Board (SMIB), Slot Interface Board (SIB), Gaming Machine Unit (GMU), or Slot Accounting System (SAS) port.

In another aspect of the invention, a connection from the printer to the SMIB, SIB, and/or GMU only monitors the connection and/or piggybacks the SMIB, SIB and/or GMU that connects to the slot machine or game; the printer receiving information and not controlling the slot machine or game.

### BRIEF DESCRIPTION OF THE DRAWINGS

These and other features, aspects, and advantages of the present invention will become better understood with regard to the following description, accompanying drawings and appendix where:

FIG. 1 is an illustration of the main aspects of a promotional couponing system in accordance with an exemplary embodiment of the present invention;

FIG. 2 is a diagram illustrating the components of the promotional couponing system in accordance with an exemplary embodiment of the present invention;

FIG. 3 is a process flow diagram of the promotional couponing system in accordance with an exemplary embodiment of the present invention;

FIG. 4 is a process flow diagram of the promotional couponing system including routing devices in accordance with an exemplary embodiment of the present invention;

FIG. 5 is an illustration of the attributes of the print regions of a promotional coupon template in accordance with an exemplary embodiment of the present invention;

FIG. 6 is an illustration of triggers in accordance with an exemplary embodiment of the present invention;

FIG. 7 is an illustration of the attributes of the communication settings with a printer in accordance with an exemplary embodiment of the present invention;

FIG. 8 is an illustration of the attributes of the printer settings in accordance with an exemplary embodiment of the present invention;

FIG. 9 is an illustration of the data transmitted to and stored in the memory of a printer for promotional coupons, promotions, and promotional campaigns in accordance with an exemplary embodiment of the present invention;

FIG. 10 is a flow chart of a load, check, and verify CRC process for a promotional campaign in accordance with an exemplary embodiment of the present invention;

FIG. 11 is a process flow diagram for gaming vouchers and promotional data in a gaming environment in accordance with an exemplary embodiment of the present invention;

FIG. 12 is an illustration of the servers, cluster controllers, games, and components thereof used for a promotional couponing system in a gaming environment in accordance with an exemplary embodiment of the present invention;

FIG. 13 is a process flow diagram for a promotional couponing system in a gaming environment for the management, issuance, and redemption of promotional coupons as related to point-of-sale purchases in accordance with an exemplary embodiment of the present invention;

FIG. 14 is an illustration of a promotional coupon including logical fields in accordance with an exemplary embodiment of the present invention;

FIG. 15 is an illustration of a promotional couponing system and game connections thereof in accordance with an exemplary embodiment of the present invention; and

APPENDIX A is a list of definitions of terms as used herein.

Identically labeled elements appearing in different ones of the figures refer to the same elements but may not be referenced in the description for all figures.

### DETAILED DESCRIPTION OF THE INVENTION

The present invention is a promotional couponing system which defines coupon templates written in a template definition language, promotions, and promotional campaigns for the creation and management of promotional coupons, promotions, promotional campaigns, and triggers using a host system and a graphical front-end to a template definition language for the generation and issuance of promotional coupons in real time, based on a predetermined date and/or time, or based on other triggers by a printer for use in a gaming, vending, or other business environment. In addition, the promotional couponing system manages the redemption of promotional coupons.

The inventors have observed that while there are various means to currently provide promotions to customers, improvements to such exist.

For example, this invention offers an improvement to existing systems by allowing an establishment to design coupons and promotional programs such that the coupons may be issued in a variety of different gaming and retail points of contact with customers.

For example, gaming establishments currently use multiple promotion methods to induce individuals to patronize the gaming establishment or associated gaming establishments. However, there is no method or system in place to create, issue, and manage promotional coupons, promotions, and promotional campaigns that may be transmitted to, stored in, and used by a printer already installed within a cashless enabled gaming machine system or game.

In addition, vending machine manufacturers have increasingly added additional printing features to their vending machines. One of these features is the ability to create promotional coupons from the vending machines. However, there is no method or system in place to create, issue, and manage promotional coupons, promotions, or promotional campaigns that may be transmitted to, stored in, and used by a printer.

There are a number of existing methods or system currently in place that accomplish some type of promotional coupon issuance or generation. In one existing method for promotional coupons is a system that edits the layout of a coupon template. While this method allows a user to design coupons, it does not allow the association of coupons to one or more promotions or the association of one or more promotions to a promotional campaign. Another problem with this method is the inability to copy coupon print regions from one coupon template to another template.

In another existing method for promotional coupons is the direct mailing of coupons from a gaming or other business establishment to consumers. One problem that plagues this existing method is that the promotion must be planned well in advance to accommodate the printing and mailing of the promotional coupons to consumers. Another problem is direct mailing and printing is not cost effective. Another problem is that the preprinted promotional coupons cannot be directly inserted into or read by a bill acceptor in a gaming or vending machine. The preprinted promotional coupons must be processed by hand, the process which lends itself to fraud and security issues such as forgery.

Another existing method for promotional coupons provides consumers the means to download promotions from a networked environment (typically the Internet) for a gaming or other business establishment. In addition to some of the problems cited for the previously described existing methods, problems for this existing method also include the lack of the consumer's presence at a gaming or other business establishment, which reduces the promotion's overall effectiveness and coupon redemption.

In another related existing method is the issuance of comps by a gaming establishment to a consumer. Comps typically include free meals, drinks, show tickets, special room rates, room upgrades, match play coupons, and free cash. One problem with this existing method is that the comp is usually processed or issued by a cashier, pit boss, or floor person whereby it must be determined if the consumer should receive a comp.

The present invention described herein provides solutions to the problems of these and other existing methods. For example, a restaurant opens down the street from a movie theatre. The movie theatre, equipped with a kiosk or multiple kiosks, each coupled to a printer, can issue movie tickets directly to a consumer. The restaurant wants to promote their business by offering customers of the movie theatre a buy-one-get-one-free dinner. The restaurant pays the movie theatre to advertise this promotion using promotional coupons generated from each printer in each kiosk at the movie theatre. The movie theatre or the restaurant creates the promotion and the promotional coupon for the restaurant using the present invention described herein. In addition, parameters and triggers for the promotion such as start and end date and time are set. The data for the promotion and promotional coupon may be saved on a host system. This data may be then transmitted to a printer in each kiosk at the movie theatre. Based on the criteria set up for the promotion, a consumer can receive the promotional coupon for the restaurant when the consumer purchases a movie ticket from a kiosk at the movie theatre.

In another example, a gaming establishment desires to create a promotion for a new cashless enabled slot machine by offering match play coupons. Using the present invention described herein, a gaming establishment creates a promotional coupon for the match play promotion. Parameters and triggers for the promotion such as start and end date and time, and number of coupons to issue are set. The data for the match play promotion and promotional coupon may be saved on a host system and sent to a printer in one or more cashless enabled gaming machines. After a consumer plays and cashes out of a cashless enabled gaming machine, and if the criteria set for the promotion is met, the consumer receives the match play promotional coupon. The consumer can then play the new cashless enabled slot machine using the match play promotional coupon by inserting the match play promotional coupon into the bill acceptor of the new cashless enabled slot machine.

In another solution to existing methods, the present invention can create promotional coupons, promotions, and promotional campaigns in real time, thereby allowing up-to-the minute or last-minute implementations. For example, a gaming establishment desires to create a last-minute promotion to issue a promotional coupon to consumers who have played for more than two consecutive hours on the same gaming machine. Using the present invention described herein, the gaming establishment creates the promotional coupon template and the promotion. The data for the promotional coupon and promotion may be saved on the host system and sent to a printer in one or more cashless enabled gaming machines. If the criteria set for the promotion is met, the printer then issues the promotional coupon to a consumer who plays for more than two consecutive hours on the same gaming machine.

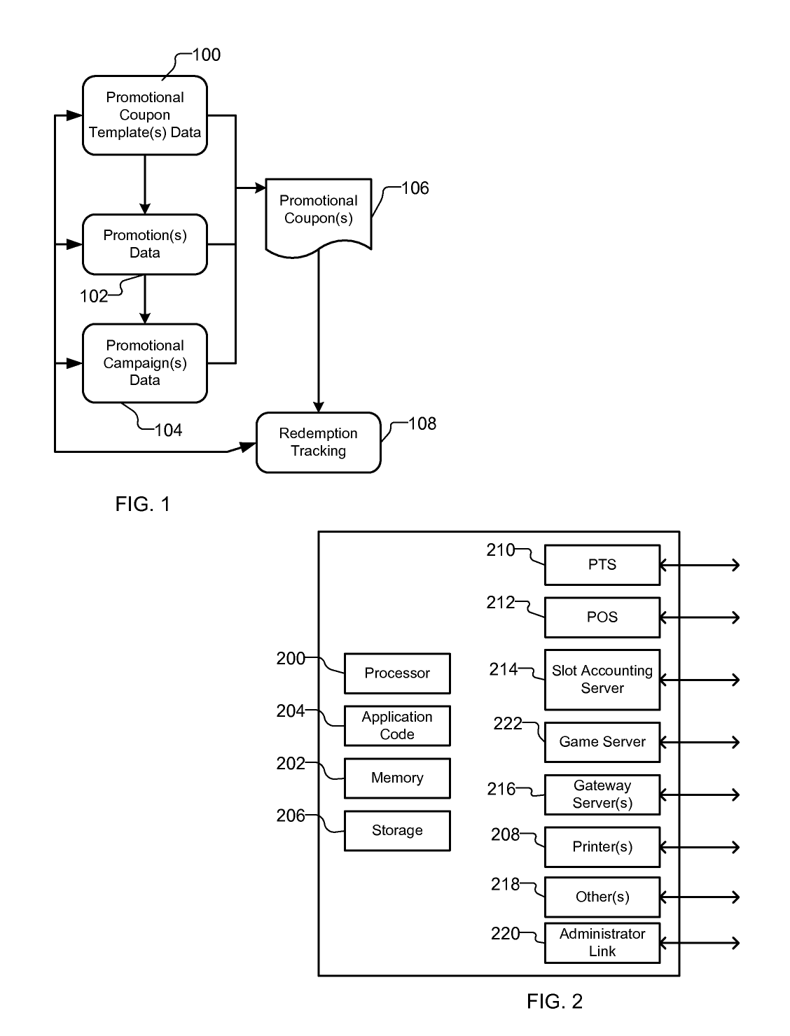

FIG. 1 is an illustration of the main aspects of a promotional couponing system in accordance with an exemplary embodiment of the present invention.

As illustrated, a promotional couponing system may use data 100 from a promotional coupon template or plurality of such, a promotion 102 or plurality of promotions, a promotional campaign 104 or a plurality of promotional campaigns, for the generation of a promotional coupon 106 or plurality of such, after which redemption of the promotional coupon is tracked (108).

Promotional coupons include coupons for merchandise, food, beverages, parking, lodging, special events such as a boxing or a tournament, personal events such as a birthday or an anniversary, entertainment, and a free play of a game or certain types of games. These promotional coupons can offer a discount, a refund, a rebate, or a free product or service.

Promotional coupon templates used to generate promotional coupons may be associated with one or a plurality of promotions based on triggers such as an issue period.

Promotions include those for a tangible or intangible product, a service, an event, and lodging. Promotions may be associated with one or a plurality of promotional campaigns. In addition, promotional campaigns include those for events such as a holiday, contest, drawing, tournament, and other special events such as boxing.

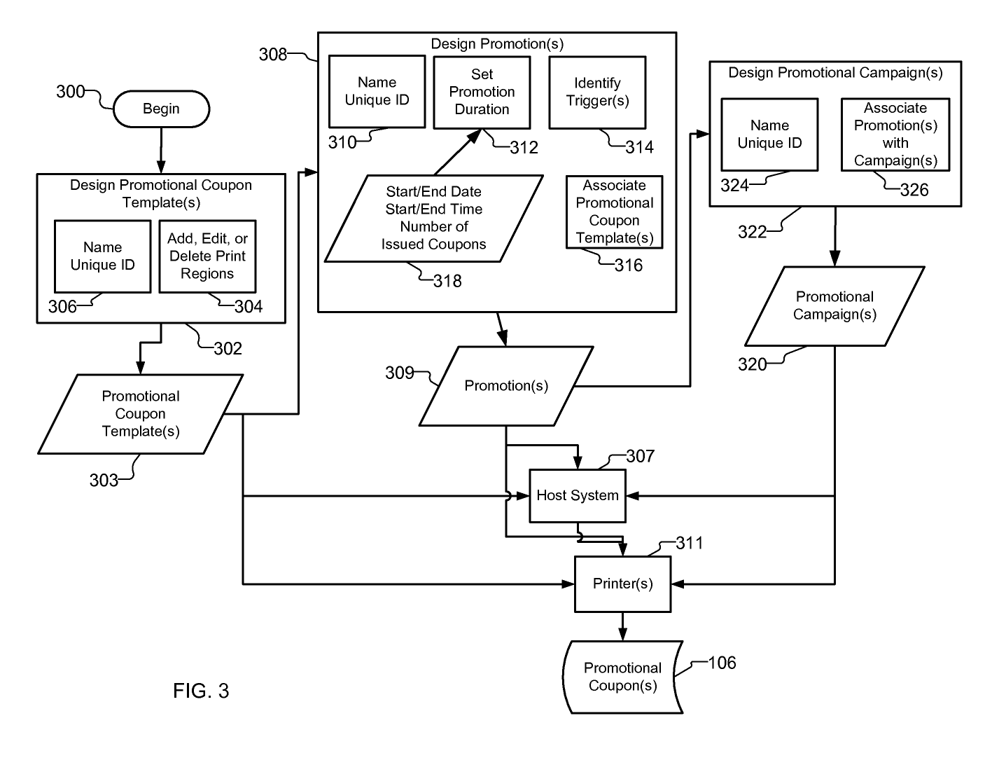

A promotional coupon template or plurality of such also may be associated with one or a plurality of promotions based on triggers described in FIG. 3, FIG. 6 and throughout this specification. Promotions may be associated with a promotional campaign or plurality of such.

After a promotional coupon 106 is issued, redemption tracking 108 of such may be based on promotional coupon template data 100, promotion data 102, or promotional campaign data 104.

FIG. 2 is a diagram illustrating the components of the promotional couponing system in accordance with an exemplary embodiment of the present invention. A component or plurality of components shown in FIG. 2 could be optional.

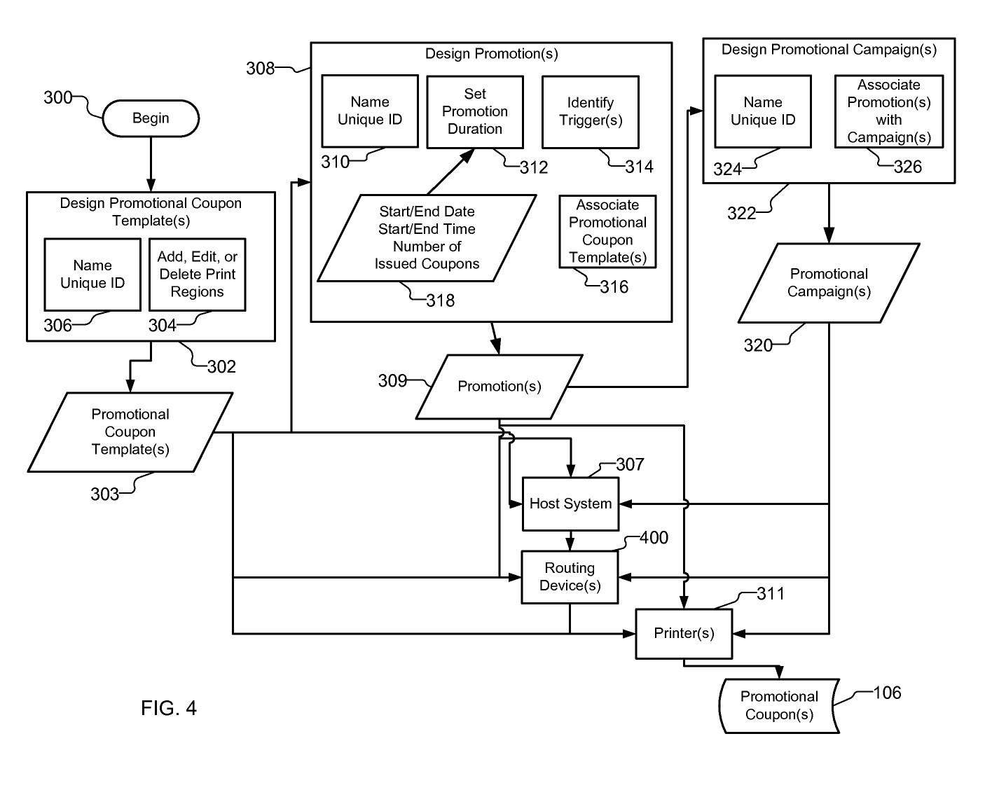

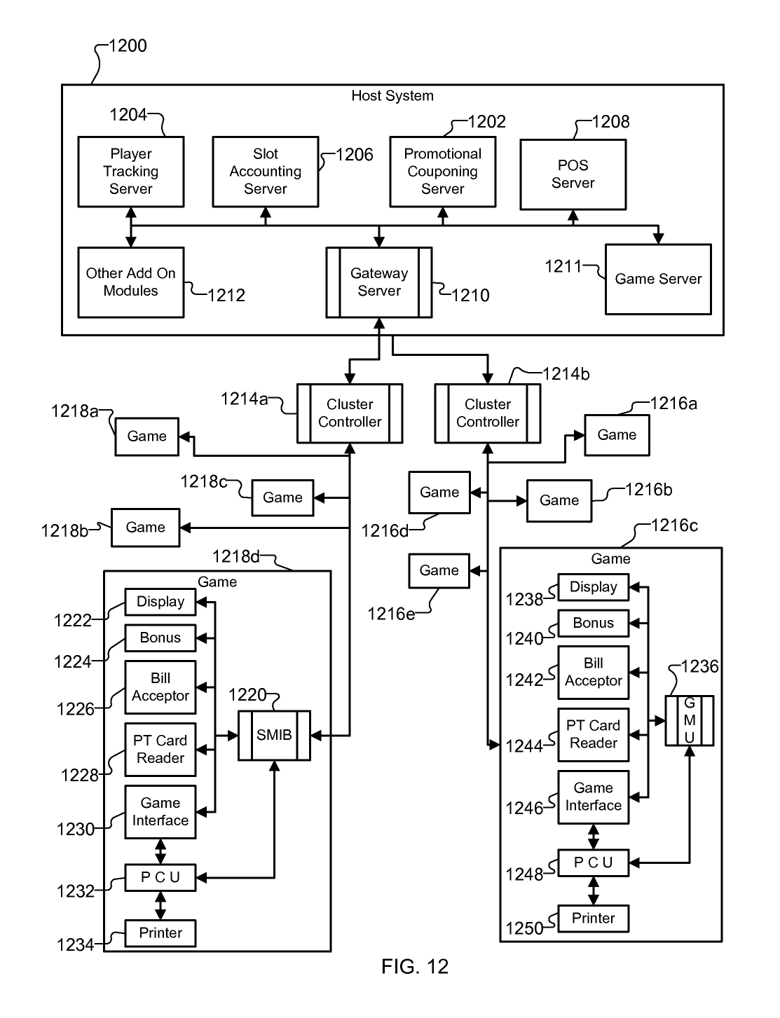

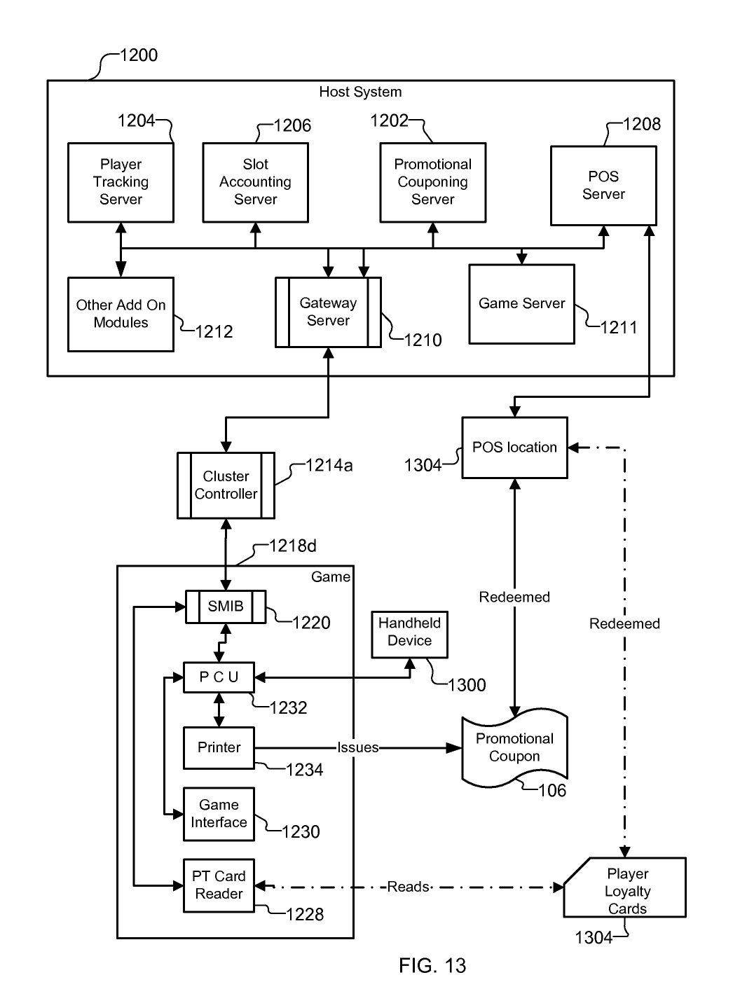

As shown in FIG. 2, the promotional couponing system comprises a processor 200, memory 202, application code 204 containing code for implementing the processes described herein, storage 206, and a plurality of interfaces to external devices and systems including an interface 208 to a plurality of printers. An exemplary device for the promotional couponing system would be a traditional network server. In FIG. 2, the processor, executing the application code, performs the following tasks, among others:
(a) create and maintain a database for storing promotional coupon template 100, promotion 102, promotional campaign 104 (all of FIG. 1), triggers 600 (of FIG. 6), and redemption data, then recalling any of that data at a later time to create a promotional coupon or plurality of such through one of its connected printers, either directly or through a coupled component such as a gateway.
(b) process data related to the creation of promotional coupon templates 100, promotions 102, and promotional campaigns 104 (all of FIG. 1), the data including triggers 600 (of FIG. 6).
(c) process data related to the issuance of promotional coupons 106 (of FIG. 1), the data including triggers 600 (of FIG. 6).
(d) process data related to the redemption of promotional coupons 108 (of FIG. 1).
(e) record and log its activities for statistical and monitoring purposes.
(f) transfer statistical data and activity logs and records to the promotional couponing system administrator using the system's interface to the Administrator 220.
(g) accept programming through its interface to a promotional couponing system administrator 220 as to the algorithms, metrics, and triggers utilized for the creation of a promotional coupon template or plurality of such.
(h) set communication options for both vouchers and promotional coupons to print using the same printer, including initializing each port and polling each printer.
(i) calculate the CRC based on promotional coupon or promotion data; thereafter, based on successful verification of the CRC, loading the promotional coupon or promotion data and sending the CRC to a printer or plurality of printers, either directly or through a coupled component such as a gateway.
(j) request data exchange through the promotional couponing system's interface to the PTS 210 to determine if a promotional coupon or plurality of such 106 (of FIG. 1) is triggered as a result of a player being a member of a frequent player or membership club of a gaming establishment.
(k) request data exchange through the promotional couponing system's interface to the PTS 210 to query player tracking data for the customization of a promotional coupon or plurality of such 106 (of FIG. 1).
(l) request data exchange through the promotional couponing system's interface to the PTS 210 to determine the validity of the redemption 108 (of FIG. 1) of a promotional coupon or plurality of such 106 (of FIG. 1), thereby enabling player tracking data is validated against data originally used for a promotional coupon, a promotion, a promotional campaign, a plurality of any, or a combination of any.
(m) request data exchange through the promotional couponing system's interface to the POS 212 for the issuance of a promotional coupon or plurality of such 106 (of FIG. 1), whereby a trigger or plurality of triggers 600 (of FIG. 6) using data from the POS is used.
(n) request data exchange though the promotional couponing system's interface to the POS 212 to monitor and track the redemption 108 (of FIG. 1) of a promotional coupon or plurality of such, whereby point-of-sale data may be verified against data originally used to create a promotional coupon template 100, promotion 102, promotional campaign 104 (all of FIG. 1), a plurality or combination of any.
(o) request data exchange through the promotional couponing system's interface to the Slot Accounting Server 214 for the issuance of a promotional coupon or plurality of such 106 (of FIG. 1), whereby a trigger or plurality of triggers 600 (of FIG. 6) using data from the Slot Accounting Server is used.
(p) request data exchange through the promotional couponing system's interface to the Slot Accounting Server 214 to monitor and track the redemption 108 (of FIG. 1) of a promotional coupon or plurality of such 106 (of FIG. 1), whereby data such as issuing machine may be verified against data originally used to create a promotional coupon template 100, promotion 102, promotional campaign 104 (all of FIG. 1), a plurality of any, or a combination of any.
(q) request data exchange through the promotional couponing system's interface to a Gateway Server 216 or plurality of such for the issuance of a promotional coupon or plurality of such 106 (of FIG. 1), whereby data and one or a plurality of triggers 600 (of FIG. 6) is transmitted to each Gateway Server to permit the issuance of promotional coupons from each printer coupled to selected games.
(r) request data exchange through the promotional couponing system's interface to a Gateway Server 216 or plurality of such to monitor and track the redemption 108 (of FIG. 1) of a promotional coupon or plurality of such, whereby data from the Gateway Server or its coupled devices as later described in FIG. 12 and FIG. 13 may be verified against data originally used to create a promotional coupon template 100, promotion 102, promotional campaign 104 (all of FIG. 1), a plurality of any, or a combination of any.
(s) request data exchange through the promotional couponing system's interface to Other(s) 218, which may be any other system, network, or device such as a routing device as later described in FIG. 4 for the issuance of a promotional coupon or plurality of such 106 (of FIG. 1), whereby data and one or a plurality of triggers 600 (of FIG. 6) is transmitted to and stored in such.
(t) request the promotional couponing system's interface to network of printers 208 in the system to create a promotional coupon or plurality of such 106 (of FIG. 1).
(u) monitor the connection through the promotional couponing system's interface to the Slot Accounting Server 214 or one or a plurality of slot machines to receive

The interfaces comprising the protocols, messaging logic, hardware, and buffering necessary to exchange data with the promotional couponing system's processor and application, and among others the PTS 210, POS 212, Slot Accounting Server 214, Game Server 222, Gateway Server(s) 216, Printer(s) 208, Other(s) 218, and Administrator Link 220.

Additionally, the promotional couponing system interfaces with one or a plurality of games either directly or through a host system such as a Game Server 222. In this embodiment, the functionality is the same or equivalent to the Slot Accounting Server 214 or Gateway Server 216 where the promotional couponing system, its processor, executing the application code, performs the following tasks, among others:
(a) monitor the connection through the promotional couponing system's interface to a Game Server 222 or one or plurality of games to receive information from a game and/or to monitor game play metrics directly from a game whereby a trigger or a plurality of triggers 600 (of FIG. 6) using data from a game is used.
(b) request data exchange through the promotional couponing system's interface to a Game Server 222 or one or plurality of games for the issuance of one or more promotional coupons 106 (of FIG. 1), whereby a trigger or plurality of triggers 600 (of FIG. 6) using data from a game is used.
(c) request data exchange through the promotional couponing system's interface to a Game Server 222 or one or plurality of games to monitor and track the redemption 108 (of FIG. 1) of one or more promotional coupons, whereby data such as issuing game may be verified against data originally used to create a promotional coupon template 100, promotion 102, promotional campaign 104 (all of FIG. 1), a plurality of any, or a combination of any.
(d) request data exchange through the promotional couponing system's interface to a Game Server 222 or one or plurality of games for the issuance of one or more promotional coupons 106 (of FIG. 1), whereby data and one or a plurality of triggers 600 (of FIG. 6) is transmitted to each game to permit the issuance of promotional coupons from each printer coupled to selected games.
(e) request data exchange through the promotional couponing system's interface to a Game Server 222 or one or plurality of games to monitor and track the redemption 108 (of FIG. 1) of one or more promotional coupons, whereby data from a game and/or its coupled devices may be verified against data originally used to create a promotional coupon template 100, promotion 102, promotional campaign 104 (all of FIG. 1), a plurality of any, or a combination of any.

A number of the interfaces for the system may exist on the same physical hardware connection, the attached devices being individual or group-addressable nodes on that connection.

In another embodiment, the promotional couponing system is on its own LAN and not connected to one or a plurality of systems in use at a gaming establishment or other business establishment or shares bandwidth with one or a plurality of systems talking a different protocol, for example, it cannot control a game. Additional details are disclosed in FIG. 15.

FIG. 3 is a process flow diagram of the promotional couponing system in accordance with an exemplary embodiment of the present invention.

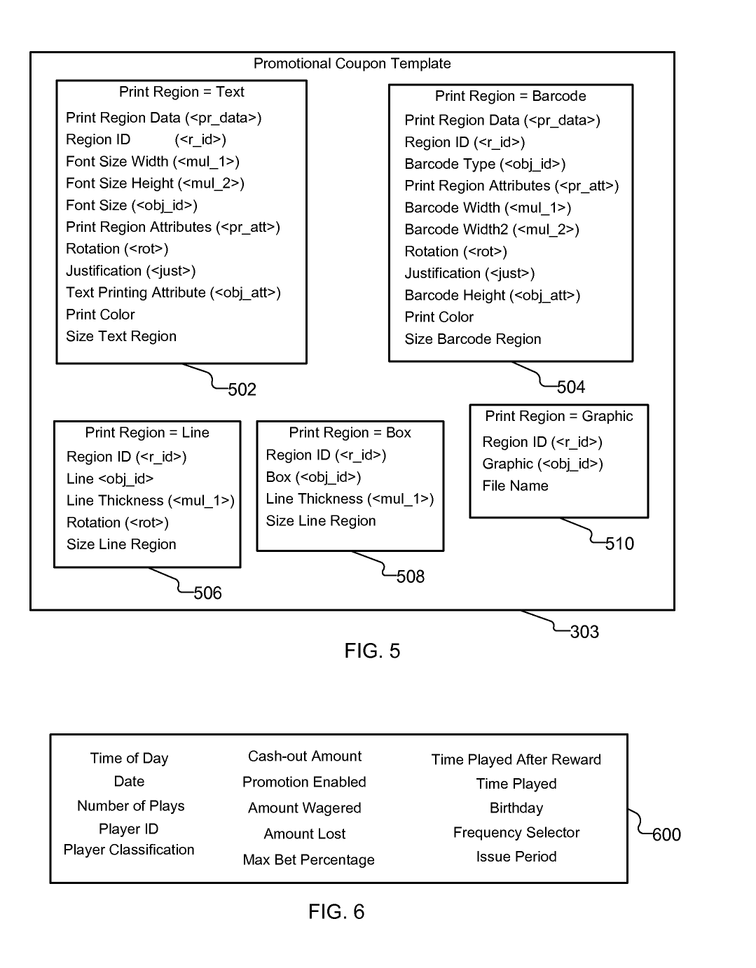

As illustrated the process begins (300) with the design (302) of a promotional coupon template 303 which is used to create promotional coupons 106. Print regions can be added, edited, or deleted (304) from a promotional coupon template. The print regions that may be included on a promotional coupon template are those described in FIG. 5. Each promotional coupon template is given (306) a name and a unique identifier. Data for each promotional coupon template may be used in a promotion or a plurality of promotions 309. The data for a promotional coupon template may be transmitted to and stored on a host system 307. All or some of the data for each promotional coupon template also may be transmitted to, stored in, and used by a printer or plurality of printers 311 to generate a promotional coupon or a plurality of promotional coupons 106.

If a promotional coupon template or plurality of promotional coupon templates 303 is used in a promotion 309 or plurality of promotions, the process continues with the design (308) of a promotion or plurality of promotions. Each promotion is given (310) a name and a unique identifier. The promotion duration is set (312), triggers are identified (314), and promotional coupon templates are associated (316). The promotion duration parameters 318 include start and end date, start and end time, and number of issued coupons, among others. The triggers may include those described in FIG. 6. The promotional coupon trigger is given a name and described. The data for each promotion may be transmitted to and stored on a host system 307. Data for each promotion also may be used in any promotional campaign or plurality of promotional campaigns 320. All or some of the data for each promotion also may be transmitted to, stored in, and used by a printer 311 or plurality of printers to generate a promotional coupon or a plurality of promotional coupons 106.

In an embodiment of the present invention, when a gaming or other business establishment desires to use a promotional coupon 106 in a promotion 309, the promotional couponing system defining promotions and promotional campaigns displays. A gaming or other business establishment defines one or a plurality of triggers 314 by which a promotional coupon or promotional coupons may be generated by a printer 311 and issued to a user or player. The event-based triggers 600 (of FIG. 6) involve factors or parameters 318 known to the printer directly or supplied by the host system 307. The triggers can operate independently or in logical combination. These triggers are used to associate a promotional coupon or a plurality of promotional coupons with a promotion or plurality of promotions. In addition, these triggers may be used when a promotion is associated with a promotional campaign or a plurality of promotional campaigns 320. These triggers include amount wagered, amount lost, rate of play, length of play, issuance per trigger, birthday, frequency selector, and issue period, among others.

Other parameters 318 used to define a promotion 309 include promotion start and end dates, a promotion ending period based on number of issued coupons, promotion start and end times, issuing a name for the promotion, assigning one or a plurality of triggers 600 (of FIG. 6) to the promotion, and selecting one or a plurality of promotional coupons 106 for use with the promotion.

The data for a promotion 309 is transmitted to and stored on the host system 307 and may be used in one or a plurality of promotional campaigns 320. Promotion data may include a unique identifier for each promotion. The data also may include the unique identifier of each associated promotional coupon 106 to interlock data in each promotion with data in each associated promotional coupon.

If a promotion or plurality of promotions 309 is to be used in a promotional campaign or plurality of promotional campaigns 320, the process continues with the design (322) of a promotional campaign or plurality of promotional campaigns. Each promotional campaign is

In an embodiment of the present invention, a user may export promotional coupon templates 303 and data for promotional coupons, promotions 309, and promotional campaigns 320 for incorporation and use by external software applications such as a casino management system or player tracking system (PTS) 210 (of FIG. 2).

In another embodiment of the present invention, when a gaming or other business establishment desires to define a promotional campaign 320, the promotional couponing system defining promotions and promotional campaigns displays. A gaming or other business establishment defines a promotional campaign by associating one or a plurality of predefined promotions 326 to the promotional campaign, assigning a name and ID 324 to the promotional campaign, and selecting a promotional coupon 106 and triggers 600 (of FIG. 6).

In another embodiment of the present invention, data for a promotional campaign 320 that may be transmitted to a printer 311 from a host system 307 or routing device 400 (of FIG. 4), stored in, and used by a printer to generate a promotional coupon 106 or a plurality of promotional coupons, may be combined with data for a promotional coupon or plurality of promotional coupons. In this embodiment, when a gaming or other business establishment desires to create or edit a promotional campaign, the promotional couponing system creates graphical displays for the promotions and promotional campaigns. After a gaming or other business establishment creates or edits a promotional campaign, the present invention inserts a tag or field in the promotional campaign data file, which identifies the promotional campaign. The present invention also calculates the CRC based on the contents of the promotional campaign data and sends the CRC to a printer or plurality of printers.

In another embodiment of the present invention, data for promotional coupon templates 303, promotions 309, and promotional campaigns 320 is stored in the memory of a printer 311. In this embodiment, the promotional couponing system transmits the data for promotional coupon templates, promotions, and promotional campaigns to a printer or plurality of such. When all parameters 318 (of FIG. 3) or triggers 600 (of FIG. 6) of a promotion or a promotional campaign are met, the printer uses the data stored in memory to generate a promotional coupon or a plurality of promotional coupons 106.

In another embodiment of the present invention, promotional campaigns can be edited or deleted. The parameters for a promotional campaign that can be edited include the promotional campaign name, promotion associations, and type of promotional campaigns, among others.

FIG. 4 is a process flow diagram of the promotional couponing system including routing devices in accordance with an exemplary embodiment of the present invention.

The process and elements are as described in FIG. 3 with the inclusion of one or more routing devices 400.

In another embodiment of the present invention, data for promotional coupon templates 303, promotions 309, and promotional campaigns 320 is stored in a routing device or a plurality of routing devices 400, each coupled to a host system 307 and a printer or a plurality of printers 311. In this embodiment, the promotional couponing system transmits the data for promotional coupon templates, promotions, and promotional campaigns to each routing device. When all the parameters 318 (of FIG. 3) or triggers 600 (of FIG. 6) for a promotion or promotional campaign are met, the routing device transmits the stored data to the printer or a plurality of printers to generate a promotional coupon or a plurality of promotional coupons 106.

FIG. 5 is an illustration of the attributes of the print regions of a promotional coupon template in accordance with an exemplary embodiment of the present invention.

As illustrated, a promotional coupon template 303 may include print regions of text 502, barcodes 504, lines 506, boxes 508, and graphics 510. All or some of the data produced by each print region may be stored partially resident in the printer 311 and partially supplied by the host system 307 (both of FIG. 3) or routing device 400 (of FIG. 4).

In an embodiment of the present invention, when a gaming or other business establishment desires to define a promotional coupon 106 (of FIG. 1), the establishment uses a promotional coupon template editor to layout print regions of text 502, graphics 510, barcodes 504, lines 506, and boxes 508. An establishment defines the layout of a promotional coupon by placing print regions on the promotional coupon template 303. For example, if the user desires to place a barcode 504 as a print region on the promotional coupon template, the user selects the barcode option to define the parameters for that barcode. The parameters include region ID, region data, region size, object ID, object rotation, object width, object justification, object attributes, print attributes, and print color among others. These parameters are also used to modify a print region.

In another embodiment of the present invention, the user can move any region to another area on a promotional coupon template 303, place a region in front of other regions, or place a region behind other regions.

In another embodiment of the present invention, a user may create multiple promotional coupon templates 303 based on existing promotional coupon templates. In this embodiment, a gaming or other business establishment selects an existing promotional coupon template on which additional promotional coupon templates are based. Each additional promotional coupon template inherits the characteristics of the selected existing promotional coupon template but can be separately modified. Using the promotional coupon template editor that displays, a gaming or other business establishment can create a new promotional coupon template, delete a selected promotional coupon template, and display or hide print regions on a promotional coupon template.

In another embodiment of the present invention, a user can adjust the workspace for structuring the promotional coupon template 303. Thus, if desired, the user can zoom in on the overall layout and print regions of a promotional coupon template to closely view and modify the overall layout and print regions. This feature also permits users to zoom out to view the overall layout and print regions of a promotional coupon template.

In another embodiment of the present invention, after the gaming or other business establishment defines the print regions for the promotional coupon template 303, the data for the promotional coupon template is stored in a document. The document contains multiple lines. A line in the document may consist of a unique identifier for the promotional coupon template, a comment, or a command and the associated parameters 318 (of FIG. 3) required to use that promotional coupon template, among others. The document is transmitted to, stored on a host system 307 and may be incorporated into a new or existing promotion 309 (both of FIG. 3). The data may also be transmitted to, stored in, and used by a printer 311 (of FIG. 3) either alone or with other promotional coupon templates to generate a promotional coupon or a plurality of promotional coupons 106 (of FIG. 1). The data may also be transmitted to and stored in a routing device or a plurality of routing devices 400 (of FIG. 4), each coupled to a host

The attributes for a text print region 502 are defined in Table I as follows:

TABLE I

| Attribute | Description |
|---|---|
| Print Region Data | Permanently stored data. Can modify if |
| (<pr_data>) | <pr_att> = dynamic, incrementing, or |
| | decrementing. |
| Region ID (<r_id>) | Print Region identifier. Unique alphanumeric |
| | character. |
| Font Size Width | The width of the size of the font. |
| (<mul_1>) | |
| Font Size Height | The height of the size of the font. |
| (<mul_2>) | |
| Font Size | An object identifier that describes the size |
| (<obj_id>) | of the font. |
| Print Region | Special handling instructions for the print region. |
| Attributes | Options for text include: Dynamic, Stored, |
| (<pr_att>) | Incrementing, or Decrementing. |
| Rotation (<rot>) | Rotation of strings or data with the print region. |
| | Options include: 0, 90, 180, or 270 Degrees. |
| Justification | Justification of data within the print |
| (<just>) | region. Options include: Left, Right, or Center. |
| Text Printing | Special handling instructions for the print |
| Attribute | object. Options for text include: Normal or |
| (<obj_att) | Inverse. |
| Print Color | Color of the print region. |
| Size Text Region | Sizing for the print region. Shrink/Enlarge |
| | Width and Height. |

The attributes for a barcode print region 504 are defined in Table II as follows:

TABLE I1

| Attribute | Description |
|---|---|
| Print Region Data | Permanently stored data. Can modify if |
| (<pr_data>) | <pr_att> = dynamic, increment, or |
| | decrement. |
| Region ID (<r_id>) | Print Region identifier. Unique alphanumeric |
| | character. |
| Barcode Type | An object identifier that describes the type of |
| (<obj_id>) | barcode used. |
| Print Region | Special handling instructions for the print |
| Attributes | region. Options for barcodes include: Dynamic, |
| (<pr_att) | Stored, Increment, or Decrement. |
| Barcode Width | The first width of the barcode. |
| (<mul_1>) | |
| Barcode Width2 | The second width of the barcode. |
| (<mul_2>) | |
| Rotation (<rot>) | Rotation of strings or data with print region. |
| | Options include: 0, 90, 180, or 270 Degrees. |
| Justification | Justification of data within print region. |
| (<just>) | Options include: Left, Right, or Center. |
| Barcode Height | The height of the barcode. |
| (<obj_att) | |
| Print Color | Color of the print region. |
| Size Barcode | Sizing for the print region. Shrink/Enlarge |
| Region | Width and Height. |

The attributes for a line print region 506 are defined in Table III as follows:

TABLE III

| Attribute | Description |
|---|---|
| Region ID (<r_id>) | Print Region identifier. Unique Alphanumeric |
| | Character. |
| Line (<obj_id>) | An object identifier that describes a line. |
| Line Thickness | The thickness of the line. |
| (<mul_1>) | |
| Rotation (<rot>) | Rotation of strings or data with print region. |
| | Options include: 0, 90, 180, or 270 Degrees. |
| Size Line Region | Sizing for the print region. Shrink/Enlarge |
| | Width and Height. |

The attributes for a box print region 508 are defined in Table IV as follows:

TABLE IV

| Attribute | Description |
|---|---|
| Region ID (<r_id>) | Print Region identifier. Unique Alphanumeric |
| | Character. |
| Box (<obj_id>) | An object identifier that describes a box. |
| Line Thickness | The thickness of the line. |
| (<mul_1>) | |
| Size Box Region | Sizing for the print region. Shrink/Enlarge |
| | Width and Height. |

The attributes for a graphic print region 510 are defined in Table V as follows:

TABLE V

| Attribute | Description |
|---|---|
| Region ID (<r_id>) | Print Region identifier. Unique Alphanumeric |
| | Character. |
| Graphic (<obj_id>) | An object identifier that describes a graphic. |
| File Name | Name of the graphic file. |

FIG. 6 is an illustration of triggers in accordance with an exemplary embodiment of the present invention.

As previously described, triggers 600 are event-based and involve factors or parameters 318 known to the printer 311 directly or supplied by the host system 307 (all of FIG. 3). These triggers can operate independently or in logical combination. These triggers are used to associate a promotional coupon or a plurality of promotional coupons 106 (of FIG. 1) with a promotion or plurality of promotions 309 (of FIG. 3).

In addition, triggers 600 may be used when a promotion 309 is associated with a promotional campaign or a plurality of promotional campaigns 320 (both of FIG. 3).

Possible triggers 600 for the issuance of a promotional coupon 106 (of FIG. 1) or plurality of such may include any or all of the following, among others:
(a) Time of day trigger uses a time of the day.
(b) Date trigger uses a date.
(c) Number of plays trigger uses a number of plays of a gaming machine.
(d) Player ID trigger uses an identification of a player. This data may be from a player tracking system.
(e) Player classification trigger uses a classification associated with a player. This data may be from a player tracking system.
(f) Cash-out amount trigger uses an amount issued at the time of cash-out of a gaming machine.
(g) Promotion enabled trigger uses the promotion when the promotion is enabled.
(h) Amount wagered trigger uses an amount played.
(i) Amount lost trigger uses an amount lost.
(j) Max Bet Percentage trigger uses a percentage based on the number of times the maximum bet button on a gaming machine is pressed.
(k) Time Played After Reward trigger uses an amount of time that a player played after a reward was issued.
(l) Time played trigger uses an amount of time that is played.
(m) Birthday trigger uses a date of birth.
(n) Frequency selector trigger uses a number of occurrences at any given time.
(o) Issue period trigger uses a period when a promotional coupon or plurality of such is issued.

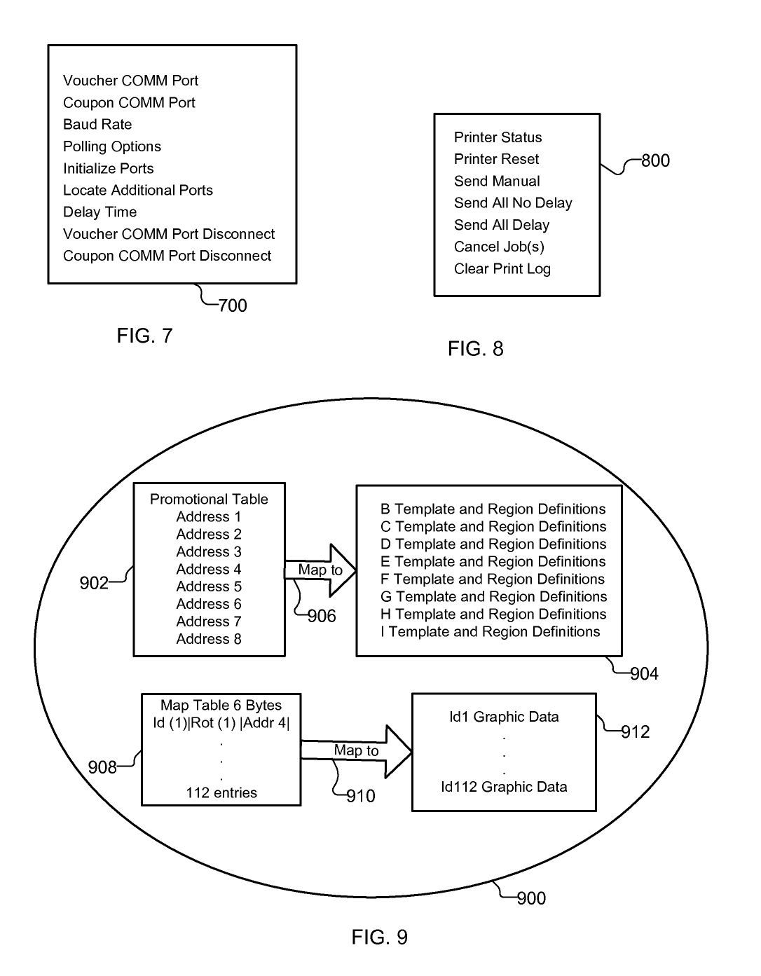

FIG. 7 is an illustration of the attributes of the communication settings with a printer in accordance with an exemplary embodiment of the present invention.

The communication settings 700 in a promotional couponing system are used to set the communication options for both vouchers and promotional coupons 106 (of FIG. 1) to print using the same printer 311 (of FIG. 3).

The following describes each attribute. Voucher COMM Port is used to identify the communication port used for voucher printing. Coupon COMM Port is used to identify the communication port used for promotional coupon 106 (of FIG. 1) printing. Baud Rate is used to set the data transmission rate for the Voucher COMM port and the Coupon COMM port. Polling Options are used on the Voucher COMM Port and the Coupon COMM port to poll the printer status. During polling, the status of the printer is sent to the promotional couponing system.

Initialize Ports is used to set up each port for data transmission. Locate Additional Ports is used to find other ports that may be available on a printer. Delay Time is used to set the time to delay printing of a voucher and a promotional coupon. Voucher COMM Port Disconnect is used to disconnect communication with the Voucher COMM Port. Coupon COMM Port Disconnect is used to disconnect communication with the Coupon COMM Port.

FIG. 8 is an illustration of the attributes of the printer settings in accordance with an exemplary embodiment of the present invention.

The following describes each attribute of the printer settings 800. Printer Status is used to determine the status of the printer 311 (of FIG. 3). Printer Reset is used to reset the printer should an error occur. Send Manual is used to manually send each print job to the printer. Send All No Delay is used to send all print jobs to the printer without delaying any of the print jobs. Send All Delay is used to send all print jobs to the printer using the Delay Time attribute of FIG. 7. Cancel Job(s) is used to cancel all print jobs currently queued to the printer. Clear Print Log is used to clear the file that logs each print job.

In an embodiment of the present invention, various methods of establishing communications with a printer 311 (of FIG. 3) for data transmission are provided. For example, when a gaming or other business establishment desires to set up the communication port to which data is transmitted to a printer, the communication port settings displays. A gaming or other business establishment selects the communication port and the communication protocol baud rate, identifies the polling option and command, and initializes the communication port. In addition, a gaming or other business establishment can locate additional communication ports to which to establish communications.

In another embodiment of the present invention, when a gaming or other business establishment desires to set up the respective communication ports to which gaming or vending vouchers and promotional coupon 106 (of FIG. 1) data is transmitted to a printer 311 (of FIG. 3), the communication ports settings displays. A gaming or other business establishment selects a gaming or vending voucher file, selects the communication port and the communication protocol baud rate, and initializes the communication port for the gaming or vending voucher. A gaming or other business establishment repeats this process for a promotional coupon.

In another embodiment of the present invention, a gaming or other business establishment can also set the delay between print option, which sets the delay print time between printing a gaming or vending voucher and printing a promotional coupon 106 (of FIG. 1). A gaming or other business establishment can also disconnect the communication port for the gaming or vending voucher, the promotional coupon, or both.

In another embodiment of the present invention, when a gaming or other business establishment desires to view the parameters of a print job prior to sending a data to a printer 311 (of FIG. 3), the print job controls a display. A gaming or other business establishment can select options such as manually sending the print job, sending all print jobs without delay, sending all print jobs with delay, canceling a print job, and clearing the output log that is created when a print job is sent to a printer.

In another embodiment of the present invention, a gaming or other business establishment can also view the status of a printer 311 (of FIG. 3). When desiring to do so, the printer status is displayed. A gaming or other business establishment can view any Universal Asynchronous Receiver Transmitter (UART) errors, view the printer library, and reset the printer if necessary.

FIG. 9 is an illustration of data transmitted to and stored in the memory of a printer for promotional coupons, promotions, and promotional campaigns in accordance with an exemplary embodiment of the present invention.

Data for promotional coupon templates, promotions, and promotional campaigns is stored in the memory of the printer. In this embodiment, the promotional couponing system transmits the data for promotional coupon templates, promotions, and promotional campaigns to a printer or plurality of such. When all parameters or triggers of a promotion or a promotional campaign are met, the printer uses the data stored in memory to generate a promotional coupon or a plurality of promotional coupons.

As illustrated, the printer memory 900 comprises a promotional table 902, template and region definitions 904, and graphics. The promotional table comprises one or a plurality of addresses. Each address is mapped (906) to a template and region definitions. For example, Address 1 may be mapped to B Template and Region Definitions, Address 2 may be mapped to C Template and Region Definitions, and so on.

Also illustrated is a map table 908 for graphics transmitted to and stored in the memory 900 of the printer 311 (of FIG. 3) for use with promotional coupons 106 (of FIG. 1). The map table comprises 6 bytes of graphic data 912 as follows: 1 byte for the object identification (ID), 1 byte for the object rotation (Rot); and 4 bytes for the object address (Addr). In this example, the map table may contain a total of 112 entries. Each entry in the table is mapped (910) to graphic data in memory 900.

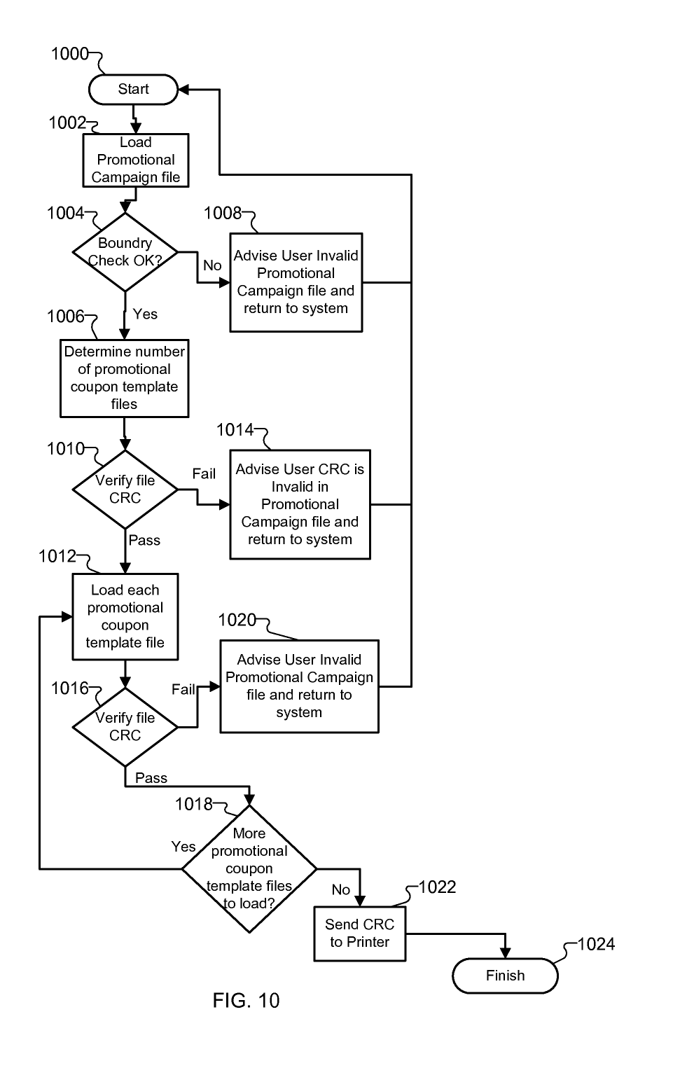

FIG. 10 is a flow chart of the load, check, and verify CRC process for a promotional campaign in accordance with an exemplary embodiment of the present invention.

As illustrated, the process begins (1000) with loading (1002) promotional campaign data. A boundary check is performed (1004). If the promotional campaign data passes the boundary check, the process continues with determining (1006) the number of promotional coupon template files. If the promotional campaign data does not pass the boundary check, the promotional couponing system advises (1008) the user and returns to the promotional couponing system.

After determining the number of promotional coupon template files, a verify file CRC (1010) is performed on the promotional campaign data. If the promotional campaign data passes the CRC verification, the process continues with the loading (1012) of each promotional coupon template. If the promotional campaign data does not pass the CRC verification, the system advises (1014) the user and returns to the promotional couponing system.

After loading each promotional coupon template, a verify file CRC is performed (1016) on each promotional coupon template in the promotional campaign data. If the promotional campaign data passes the CRC verification, the process continues with the loading (1018) of additional promotional coupon templates. If the promotional campaign data does not pass the CRC verification, the system advises (1020) the user and returns to the promotional couponing system.

After loading all promotional coupon templates is finished, the process completes with the CRC being sent (1022) to the printer and finishes (1024).

In an embodiment of the present invention, a CRC is calculated based on the contents of the promotional coupon 106 (of FIG. 1) data. In this embodiment, when a gaming or other business establishment desires to create or edit a promotional coupon template 303 (of FIG. 3), the promotional coupon template editor displays. After a gaming or other business establishment creates or edits a promotional coupon template, the present invention inserts a tag or field into the promotional coupon template data file, which identifies the promotional coupon template. The present invention then performs a boundary check on the data file and calculates the CRC based on the contents of the promotional coupon data file. After successful verification of the CRC, the present invention loads the data for each promotional coupon 106 (of FIG. 1) and sends the CRC to a printer or plurality of printers 311 (of FIG. 3).

In another embodiment of the present invention, a CRC is calculated based on the contents of the promotion data 102 (of FIG. 1). In this embodiment, when a gaming or other business establishment desires to create or edit a promotion 309 (of FIG. 3), the promotions and promotional campaigns are defined displays. After an establishment creates or edits a promotion, the present invention inserts a tag or field into the promotion data file, which identifies the promotion. The present invention then performs a boundary check on the data file and calculates the CRC based on the contents of the promotion file. After successful verification of the CRC, the present invention loads the data for each promotion and sends the CRC to a printer or plurality of printers 311 (of FIG. 3).

In another embodiment, a boundary check on the combined promotional coupon template or plurality of promotional coupon templates 303 (of FIG. 3), print regions, graphics and other data that may be included with the promotion data 102 or promotional campaign data 104 (both of FIG. 1) may be performed to ensure conformance with the resources and load requirements of the printer 311 (of FIG. 3). In this embodiment, after a gaming or other business establishment transmits data to a printer, the promotional couponing system performs the boundary check by determining the number of promotional coupon templates, print regions, graphics and other data that may be included with promotion or promotional campaign data. The promotional couponing system then verifies the CRC. After successful verification of the CRC, the promotional couponing system loads the data for each promotional coupon template and sends the CRC to a printer or plurality of printers 311 (of FIG. 3).

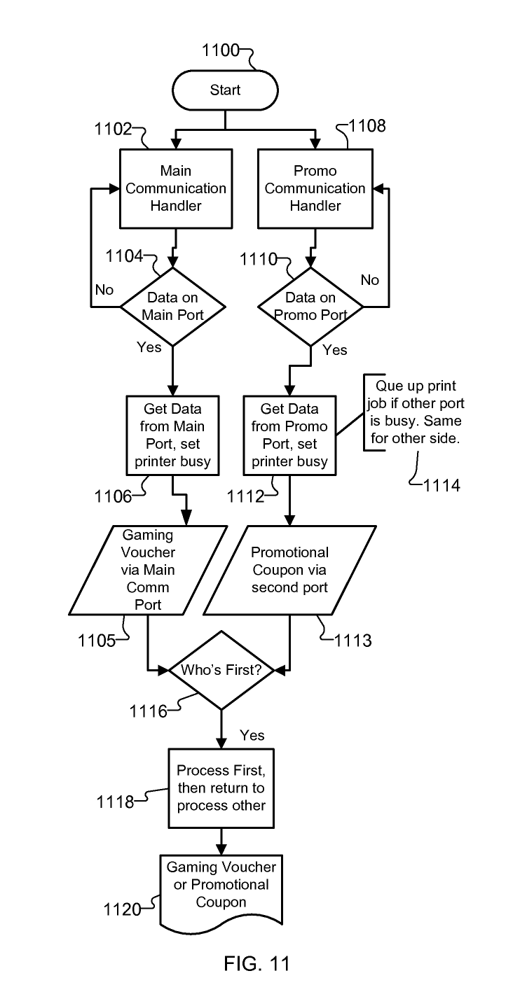

FIG. 11 is a process flow diagram for gaming vouchers and promotional data in a gaming environment in accordance with an exemplary embodiment of the present invention.

As illustrated, the process for gaming vouchers begins (1100) with a main communication handler 1102. If data, such as a gaming voucher, exists (1104) on the main port, the system gets the data 1105 from the main port and sets the printer to busy (1106). If data does not exist on the main port, the process returns to the main communication handler.

The process for promotional coupons begins with a promo communication handler 1108. If data such as a promotional coupon exists (1110) on the promo port, the system gets the data (1113) from the promo port and sets the printer to busy 1112. If data does not exist on the promo port, the process returns to the promo communication handler.

If the printer is busy using any port, the data from the other port is queued (1114). The process continues with the promotional couponing system identifying (1116) which data was received first. After identifying the data received first, the promotional couponing system processes (1118) the first data to generate (1120) a gaming voucher or promotional coupon, then returns to process the second data to generate a gaming voucher or promotional coupon.

FIG. 12 is an illustration of the servers, cluster controllers, games, and components thereof used for a promotional couponing system in a gaming environment in accordance with an exemplary embodiment of the present invention. A component or plurality of components shown in FIG. 12 could be optional.

As illustrated, a host system 1200 includes a promotional couponing server 1202, a player tracking server 1204, a slot accounting server 1206, a POS server 1208, a gateway server 1210, a Game Server 1211, and other add on modules 1212, each coupled to each other.

The promotional couponing server 1202 processes data related to promotional couponing such as that described in FIG. 3, FIG. 4, FIG. 5, FIG. 6, FIG. 10, and FIG. 11 as well as throughout this specification. For example, to create a promotional coupon 106 (of FIG. 1) using a birthday as a trigger 600 (of FIG. 6) and an issuing location, the promotional couponing server may query data such as a player's date of birth from the player tracking server 1204 and machine information from the slot accounting server 1206. To continue with this example, before the promotional coupon can be redeemed at a point-of-sale location, the POS server 1208 may query the player tracking system for a player's date of birth. Additional details are disclosed in FIG. 2 and FIG. 13.

The POS server 1208 also may query the slot accounting server 1206 to validate machine information such as issuing location. The POS server also may query the promotional couponing server 1202 to validate data for the promotional coupon 106 (of FIG. 1) such as the unique identifier for the promotional coupon.

The player tracking server 1204 processes data related to player tracking For example, the promotional couponing server 1202 may query data such as a player's name from the player tracking server to customize a promotional coupon 106 (of FIG. 1) with the name of an individual.

The slot accounting server 1206 processes data related to slot machines. For example, the promotional couponing server 1202 may query data such as the machine identification from the slot accounting server to unique identify the originating machine that issued a promotional coupon 106 (of FIG. 1).

The POS server 1208 processes data related to promotional coupon 106 (of FIG. 1) redemption and point-of-sale purchases. For example, in order to validate a promotional coupon for redemption, the POS server may query data such as the unique identifier for the promotional coupon from the promotional couponing server 1202.

The Game Server 1211 processes data related to games such as gaming tables. For example, the promotional couponing server 1202 may monitor and query the game server for data such as game play metrics to issue a promotional coupon 106 (of FIG. 1).

Other add-on modules 1212 process data and support other systems such as a lodging management system, among others. For example, to redeem a promotional coupon 106 (of FIG. 1) for a discount on lodging, a lodging management system may query the promotional couponing server 1202 to validate the promotional coupon.

The gateway server 1210 is coupled to one or more cluster controllers, such as cluster controllers 1214a and 1214b. Each cluster controller further is coupled one or more games. For example, cluster controller 1214b is coupled to games 1216a to 1216e and cluster controller 1214a is coupled to games 1218a to 1218d. Each cluster controller controls the operation of the associated games. For example, one cluster controller may be used for games located at the north end of a casino floor while another cluster controller may be used for games located at the south end of the casino floor.

Each game such as a slot machine 1218d may comprise a Slot Machine Interface Board (SMIB) 1220, the SMIB coupled to various components that may include a display 1222, bonusing 1224, bill acceptor 1226, Player Tracking (PT) card reader 1228, game interface 1230, and a Printer Controller Unit (PCU 1232) for controlling a printer 1234.

Each game such as a gaming table 1216c may comprise a Game Machine Unit Board (GMU) 1236, the GMU coupled to various components that may include a display 1238, bonusing 1240, bill acceptor 1242, Player Tracking (PT) card reader 1244, game interface 1246, and a Printer Controller Unit (PCU 1248) for controlling a printer 1250.

The game interface of either game such as a slot machine 1230 or gaming table 1246 also may be coupled to a printer controller unit 1232 and 1248. The printer controller unit further is coupled to a printer such as 1234 and 1250.

The gateway server 1210 processes data and convert protocols from all other servers to a cluster controller or a plurality of such. For example, data for the issuance of a promotional coupon 106 (of FIG. 1) or plurality of such is sent from a promotional couponing server 1202 and any of the other servers in a host system 1200 through a gateway server to each cluster controller 1214a and 1214b. The data is then forwarded to the associated games or to selected games. The data resides in the printer controller unit (PCU 1232 and 1248) until a trigger or a plurality of triggers as described in FIG. 6 is met. Thereafter, the data is used by the printer such as 1234 and 1250 to generate a promotional coupon or plurality of such.

FIG. 13 is a process flow diagram for a promotional couponing system in a gaming environment for the management, issuance, and redemption of promotional coupons as related to point-of-sale purchases in accordance with an exemplary embodiment of the present invention. A component or plurality of components shown in FIG. 13 could be optional.

FIG. 13 includes all the components described in FIG. 12. An additional component is a handheld device 1300. The handheld device may be used to download data for a promotional coupon template 303, a promotion 309, a promotional campaign 320 (all of FIG. 3), a plurality of any, or a combination of any to a printer controller unit (PCU 1232) for the issuance of a promotional coupon 106 or plurality of such.

As illustrated, a promotional coupon 106 is issued from a printer 1234 in a game such as a slot machine 1218d. When the promotional coupon is redeemed at a point-of-sale location 1304, the POS server 1208 gathers data from the promotional coupon and queries the other servers in a host system 1200 to validate any or all of that data. Upon successful validation, the promotional coupon is redeemed. In another embodiment not illustrated, a promotional coupon 106 is issued from a printer in a game such as a gaming table 1250 (of FIG. 12).

Also illustrated is a correlation between promotional coupons 106 and player loyalty cards 1304. For example, data sent from the host system may include a trigger 600 (of FIG. 6) based on player tracking information such as player identification. When the player tracking card reader 1228 of a slot machine reads a player loyalty card and identifies the player, the trigger is set and a promotional coupon may be generated by the printer such as 1234. In addition, the player loyalty card may be used to verify or validate a promotional coupon when that promotional coupon is redeemed.

In one embodiment of the present invention, the promotional couponing system 1200 monitors and tracks the redemption of promotional coupons 106. When a promotional coupon is redeemed at a point-of-sale location 1304 such as a store or restaurant, data gathered from the promotional coupon is transmitted to the promotional couponing system. For example, this data may come from barcode data, the unique identifier for each promotional coupon, or a combination thereof, among others.

In another embodiment of the present invention, to allow redemption of the promotional coupon 106, the data may be verified against data originally used to create a promotional coupon template 303, promotion 309, promotional campaign 320 (all of FIG. 3), a plurality of any, or a combination of any. If the data from the promotional coupon meets any condition or parameter originally set, the promotional coupon is redeemed.

In another embodiment of the present invention, the promotional couponing server 1202 is coupled to a point-of-sale server 1208 to validate the redemption of promotional coupons 106. Data gathered from a promotional coupon being redeemed is validated against data originally set for a promotional coupon, a promotion 309, a promotional campaign 320 (both of FIG. 3), a plurality of any, or a combination of any. If the data from the promotional coupon meets any condition or parameter originally set, the promotional coupon is redeemed.

In another embodiment of the present invention, the promotional couponing server 1202 is coupled to a player tracking server 1204 to validate the redemption of promotional coupons 106. Player tracking data used with promotional coupon, promotion 309, or promotional campaign data 320 (both of FIG. 3) is validated against data originally used for a promotional coupon, a promotion, a promotional campaign, a plurality of any, or a combination of any. If the data is verified, the promotional coupon is redeemed.

In another embodiment of the present invention, the promotional couponing server 1202 is coupled to a slot accounting server 1206 to request data for the issuance of a promotional coupon 106 or plurality of such based on a promotional coupon template 303 (of FIG. 3). For example, using the invention described herein, a gaming establishment creates a promotional campaign 320 (of FIG. 3), which uses a trigger 600 (of FIG. 6) that issues a promotional coupon after a player plays 15 times on the same slot machine. The trigger uses data from the slot accounting server. Once the conditions and parameters of the trigger are met, a promotional coupon is issued. In another example, a trigger for amount wagered may be used to request amount wagered data from the slot accounting server. Once such data is received from the slot accounting server, a promotional coupon is issued.

In another embodiment of the present invention, the promotional couponing server 1202 is coupled to a slot accounting server 1206 to verify the issuance and validate the redemption of a promotion coupon 106 or plurality of such based on a promotional coupon template 303 (of FIG. 3). For example, data originally set in a promotional coupon template may include a machine identification. When a promotional coupon is issued, the identification of the issuing machine is transmitted from the slot accounting server and placed on a promotional coupon. When a promotional coupon is redeemed, the promotional couponing system verifies the data from the promotional coupon with the data originally set with a promotional coupon template. If the data matches, the promotional coupon is redeemed.

In a variation, one or a plurality of promotional coupons 106 do not use a promotional coupon template 303 (of FIG. 3).

In another embodiment of the present invention, the promotional couponing server 1202 is coupled to a game server 1211 to request data for the issuance of one or a plurality of promotional coupons 106.

In another embodiment of the present invention, the promotional couponing server 1202 is coupled to a game server 1211 to verify the issuance and validate the redemption of one or a plurality of promotional coupons 106.

In another embodiment of the present invention, the promotional couponing system monitors the connection through the promotional couponing system's interface to the Slot Accounting Server 214 (of FIG. 2) or one or a plurality of slot machines such as 1218d to receive information from a slot machine and/or to monitor slot machine play metrics directly from a slot machine whereby a trigger 600 (of FIG. 6) or a plurality of triggers using data from the slot machine is used.

In another embodiment of the present invention, the promotional couponing system monitors the connection through the promotional couponing system's interface to a game server 222 (of FIG. 2) or one or a plurality of games such as 1216c (of FIG. 12) to receive information from a game and/or to monitor game play metrics directly from a game whereby a trigger or a plurality of triggers using data from a game is used.

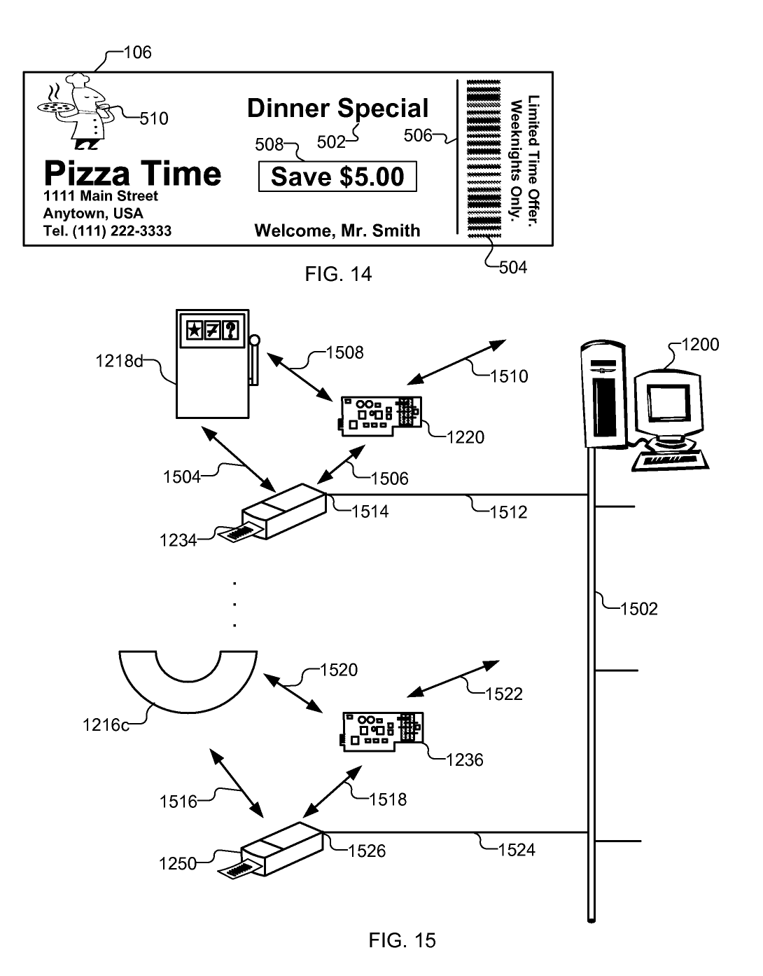

FIG. 14 is an illustration of a promotional coupon including logical fields in accordance with an exemplary embodiment of the present invention. In this example, a promotional coupon 106 may include five types of print regions: text 502, barcode 504, graphic 510, line 506, and box 508 as described in FIG. 5. The print regions of a promotional coupon template 303 (of FIG. 3) used to create this example are defined in the promotional couponing system and may be stored in a host system 307 (of FIG. 3), router 400 (of FIG. 4), printer 311 (of FIG. 3), a plurality of any or a combination of any. The template may include a plurality of print regions in combination, resulting in a paste-up style printed coupon.

The data may be stored partially resident in the printer 311 (of FIG. 3) and partially supplied by the host system 307 (of FIG. 3) or routing device 400 (of FIG. 4). The actual value of data for each print region may or may not be included in the promotional coupon template 303 (of FIG. 3). For example, a promotional coupon template may include a barcode field or region 504 for printing a barcode. However, the actual value of the barcode is transmitted to a printer at the time a promotional coupon 106 is generated using a promotional coupon

In addition, data that is used to track the usage of promotional coupons 106 may be included in a promotional coupon. For example, a barcode field or region 504 or a text field 502 may be used to print a barcode value or text string uniquely identifying the promotional coupon. In this way, a printer 311 (of FIG. 3) creates an image of a barcode or barcodes, characters or marks that may be read by a gaming or vending machine bill acceptor (1226 and 1242 of FIG. 12) on the same or another gaming or vending machine, allowing automatic acceptance of promotional coupons.

FIG. 15 is an illustration of a promotional couponing system and game connections thereof in accordance with an exemplary embodiment of the present invention.

In this embodiment, the promotional couponing system is on its own LAN 1502 and not connected to one or a plurality of systems in use at a gaming establishment or other business establishment or shares bandwidth with one or a plurality of systems talking a different protocol, for example, it cannot control the game such as 1218d and 1216c.

The LAN 1502 type illustrated is Ethernet, although any other network type may be used.

Also illustrated are a slot machine 1218d, SMIB 1220, printer 1234, and connections thereof. For example, the connection between a slot machine and printer 1504 is used for processing vouchers such as game vouchers. The connection between the printer and SMIB 1506 and the slot machine and SMIB 1508 provide an additional interface to a slot machine as well as other components of a slot machine and/or a slot accounting server 1206 (of FIG. 12). The connection from the SMIB to gaming establishment server(s) 1510 provides a connection to other systems.

In this embodiment, the printer connection uses a third port 1514 for the LAN 1502 connection of an Ethernet type to the promotional couponing system 1512.

In one aspect of the invention, the promotional couponing system 1200 monitors slot machine 1218d play metrics directly from a slot machine using a connection to the Slot Machine Interface Board (SMIB) 1220 and/or Slot Interface Board (SIB).

Also illustrated are a game 1216c, GMU 1236, printer 1250, and connections thereof. For example, the connection between a game and printer 1516 is used for processing vouchers such as game vouchers. The connection between the printer and GMU 1518 and the game and GMU 1520 provide an additional interface to a game as well as other components of a game and/or a game server 1211 (of FIG. 12). The connection from the GMU to gaming establishment server(s) 1522 provides a connection to other systems.

In this embodiment, the printer connection uses a third port 1526 for the LAN 1502 connection of an Ethernet type for the promotional couponing system 1524.

In another aspect of the invention, the promotional couponing system 1200 monitors game play metrics directly from a game 1216c using a connection to the Game Machine Unit (GMU) 1236.

In another aspect of the invention, the promotional couponing system 1200 monitors slot machine 1218d play metrics and/or game 1216c play metrics using a connection with a Slot Accounting System (SAS) port.

In another aspect of the invention, a connection from the printer to the SMIB 1506, SIB, and/or GMU 1518 only monitors the connection and/or piggybacks the SMIB 1220, SIB and/or GMU 1236 that connects to the slot machine 1218d or game 1216c; the printer receiving information and not controlling the slot machine or game.

Although the invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by any claims supportable by this application and the claims' equivalents rather than the foregoing description.

### APPENDIX A—LIST OF TERMS

For the purposes of this application the following definitions apply:
“Gaming Establishment”—A gaming entity such as a casino.
“Business Establishment”—A business entity that may use a kiosk for consumer purchases such as movie tickets, parking tickets, venue tickets, etc., or a retail business entity.
“Game”, “Gaming Machine”, or “Game Machine”—A slot machine, gaming machine, or game table in a gaming establishment.
“Host System”—A computer, back-end system, gaming system, network, or other system that sends and/or receives information to and/or from a game, printer or other component in a game or gaming table. Examples include a wagering issuance and redemption system, cash-out voucher system, a player tracking system, and a promotional couponing system, among others.
“Point of Redemption”—Any kiosk, point-of-sale, cashier's cage, or other where a player redeems a game voucher and/or promotional coupon.
“Voucher”, “Game Voucher”—Media, such as paper or rewritable card, containing information to identify at a minimum, amount of money and validation number to authenticate transaction.
“Promotional Coupon”—Media, such as paper or rewritable card, containing sufficient information to identify at a minimum, a promotional event or a promotional reward to a player and validation information.
“CRC”—Acronym for Cyclic Redundancy Check. Commonly used mathematical formula used as a signature for binary image of firmware or data included in the sectional memory of a printer.
“Printer”—A printing device coupled to a cashless enabled game, a vending machine or kiosk, or a point-of-sale system.
“Print Region”—A print object as text, barcode, line, box, or graphic, used on a template that describes where to put the print object on a coupon or voucher, how to print the print object, the orientation of print (0,90, etc.), and other special control factors.
“Template”—Collection of Print Regions referenced by a single identification byte that is used to format the positioning of Print Regions on a coupon or voucher.
“Printer Controller Unit”—A device internal or external to a printer that controls print jobs and receives and/or transmits data, among other functions.
“PTS”—Acronym for Player Tracking System.
“POS”—Acronym for Point Of Sale system.

1. A method of promotional couponing, comprising:
storing, by a handheld routing device, a coupon template used for promotional couponing;
interfacing, by the handheld routing device, to a printer controller unit controlling a printer in a gaming machine;
downloading, by the handheld routing device, the coupon template to the printer controller unit;
monitoring, by the printer controller unit, game play metrics directly from the gaming machine using a connection to a Game Machine Unit of the gaming machine; and
printing, by the printer controller unit, a promotional coupon using the printer in the gaming machine, the game play metrics and the coupon template.

2. The method of claim 1, further comprising sending, by the Game Machine Unit via a communications network, the game play metrics directly from the gaming machine to an accounting server.

3. The method of claim 1, wherein the gaming machine is a slot machine having a Slot Machine Interface Board, the method further comprising monitoring game play metrics directly from the slot machine by an accounting server using a connection to the Slot Machine Interface Board via a communications network.

4. The method of claim 2, further comprising:
generating, by a promotional couponing server using the game play metrics, a trigger used to trigger printing of the coupon;
sending the trigger to the printer controller unit via the communications network, wherein the printer controller unit prints the coupon using the printer and the coupon template in response to the trigger.

5. The method of claim 3, further comprising:
generating, by a promotional couponing server using the game play metrics, a trigger used to trigger printing of the coupon;
sending the trigger to the printer controller unit via the communications network, wherein the printer controller unit prints the coupon using the printer and the coupon template in response to the trigger.

6. A promotional couponing system, comprising: a printer controller unit constructed to:
control a printer of a gaming machine; interface to a handheld routing device; download from the handheld routing device, a coupon template.
monitor game play metrics directly from the gaming machine using a connection to a Game Machine Unit of the gaming machine; and
print a coupon using the printer and the coupon template, and a handheld routing device constructed to:
store the coupon template used in the promotional couponing system;
interface to the printer controller unit; and
download the coupon template to the printer controller unit.

7. The promotional couponing system of claim 6, wherein the gaming machine is a slot machine having a slot machine interface board constructed to send slot machine play metrics directly from the slot machine to an accounting server via a communications network.

8. The promotional couponing system of claim 6, wherein the gaming machine has a game machine unit constructed to monitor game play metrics directly from the gaming machine by an accounting server using a connection to the game machine unit via a communications network.

9. The promotional couponing system of claim 7, further comprising:
a couponing server constructed to:
use the game play metrics to generate a trigger used to trigger printing of the coupon; and
send the trigger to the printer controller unit via the communications network,
wherein the printer controller unit is further constructed to print the coupon using the printer and the coupon template in response to the trigger.
